(19) United States
(12) Patent Application Publication
(10) Pub. No.: US 2014/0084759 A1
(43) Pub. Date: Mar. 27, 2014

(54) ELECTROMECHANICAL DEVICE, ROTOR USED FOR ELECTROMECHANICAL DEVICE, AND MOBILE UNIT AND ROBOT WITH ELECTROMECHANICAL DEVICE

(71) Applicant: Seiko Epson Corporation, Tokyo (JP)

(72) Inventor: Kesatoshi TAKEUCHI, Shiojiri (JP)

(73) Assignee: Seiko Epson Corporation, Tokyo (JP)

(21) Appl. No.: 14/033,803

(22) Filed: Sep. 23, 2013

(30) Foreign Application Priority Data
Sep. 26, 2012 (JP) 2012-211700

(51) Int. Cl. H02K 1/27; H02K 11/00

(52) U.S. Cl. CPC H02K 1/278; H02K 11/0021; Y10S 901/23
USPC 310/68 B; 310/156.22; 901/23

(57) ABSTRACT

An electromechanical device has a rotor and a stator provided on an outer circumference of the rotor. The rotor includes a rotation shaft, a plurality of rotor magnets cylindrically fixed and arranged along an outer circumference of the rotation shaft, and two magnet side yokes fixed and arranged in contact with side surfaces at both sides of the rotor magnets in a shaft direction of the rotation shaft. Overhang parts that suppress the rotor magnets with respect to radiation directions from a center of the rotation shaft toward the outer circumference and limit movements of the rotor magnets in the radiation directions are provided on surfaces of the magnet side yokes in contact with the rotor magnets.

### BACKGROUND

1. Technical Field

The present invention relates to an electromechanical device using an SPM (Surface Permanent Magnet) rotor, a rotor used for the electromechanical device, and a mobile unit and a robot having the electromechanical device.

2. Related Art

As coreless rotating electrical machines including coreless motors and coreless power generators (referred to as “coreless electromechanical device” or simply referred to as “electromechanical device” in the specification), a machine using an SPM rotor formed by bonding of a plurality of permanent magnets as a plurality of rotor magnets along the cylindrical outer circumferential surface of the rotor has been known (for example, see JP-A-2012-10572). In the coreless electromechanical device, in order to suppress leakage of magnetic flux from the rotor magnets in a direction along the rotation shaft of the rotor, magnet side yokes formed using magnetic materials are formed in both end parts of the rotor magnets along the rotation shaft of the rotor.

In the case where the load on the rotor of the coreless electromechanical device is increased by rotation at a higher speed or the like, reliability with respect to bonding and fixing of the rotor magnets becomes insufficient. Specifically, there has been a problem that the adhesive is soften due to the temperature rise of the rotor in response to the increase of the rotation speed, and the rotor magnets are loosened in the radiation directions and finally detached due to forces (centrifugal forces) in the directions (radiation directions) from the center of the rotation shaft toward the outer circumference applied to the fixed rotor magnets. Further, there has been another problem that, when the rotor magnets are bonded, it is difficult to equalize the outer circumference dimensions of the rotor magnets after bonding and fixing due to variations in viscosity of the adhesives, and to maintain characteristics in rotation at the higher speed or the like. In addition, in the electromechanical devices of related art, downsizing, cost saving, resource saving, facilitation of manufacture, improvement in user-friendliness, etc. have been desired.

### SUMMARY

An advantage of some aspects of the invention is to solve at least a part of the problems described above and the invention can be implemented as the following forms.

(1) An aspect of the invention provides an electromechanical device having a rotor and a stator provided on an outer circumference of the rotor. The electric rotor of the electromechanical device includes a rotation shaft, a plurality of rotor magnets cylindrically fixed and arranged along an outer circumference of the rotation shaft, and two magnet side yokes fixed and arranged in contact with side surfaces at both sides of the rotor magnets in a shaft direction of the rotation shaft. Further, overhang parts that suppress the rotor magnets with respect to radiation directions perpendicular to the shaft direction from a center of the rotation shaft toward the outer circumference and limit movements of the rotor magnets in the radiation directions are provided on surfaces of the magnet side yokes in contact with the rotor magnets. According to the electromechanical device of the embodiment, by the two magnet side yokes fixed and arranged on the side surfaces at both sides of the rotor magnets in the shaft direction, leakage magnetic fluxes of the rotor magnets in the shaft direction may be suppressed and loose of the rotor magnets may be prevented by limiting the movements of the rotor magnets in the radiation directions. Further, the outer circumference diameter of the rotor defined by the outer circumference of the rotor magnets may be stably held.

(2) The electromechanical device of the aspect of the invention may be configured such that the overhang parts are formed by convex parts projecting to the surface sides of the rotor magnets. According to the electromechanical device of this configuration, the overhang parts may be formed by simple structures formed on the magnet side yokes.

(3) The electromechanical device of the aspect of the invention may be configured such that concave parts that engage with the convex parts of the overhang parts are formed on the rotor magnets. According to the electromechanical device of this configuration, the cylindrical outer circumferential surfaces of the rotor magnets and the cylindrical outer circumferential surfaces of the magnet side yokes may be conformed along the shaft direction, and an unnecessary gap between the rotor and the stator may be reduced.

Note that the invention can be implemented in various forms and, for example, may be implemented in various forms including electromechanical devices such as motors and power generators, rotors used for the electromechanical devices, and electric mobile units and electric mobile robots using the electromechanical devices or medical devices.

### BRIEF DESCRIPTION OF THE DRAWINGS

The invention will be described with reference to the accompanying drawings, wherein like numbers reference like elements.

FIG. 1A is an explanatory diagram showing a configuration of a coreless motor as one embodiment of an electromechanical device.

FIG. 1B is an explanatory diagram showing the configuration of the coreless motor as one embodiment of the electromechanical device.

FIG. 1C is a schematic perspective view showing electromagnetic coils arranged along an inner circumference of a coil back yoke.

FIGS. 2A and 2B are explanatory diagrams showing a structure of surfaces at which rotor magnets and magnet side yokes are in contact.

FIGS. 3A to 3C are explanatory diagrams showing modified examples of overhang parts of the magnet side yokes.

FIGS. 4A to 4C are explanatory diagrams showing modified examples of the overhang parts of the magnet side yokes.

FIGS. 5A and 5B are explanatory diagrams showing modified examples of the overhang parts of the magnet side yokes.

FIG. 6 is an explanatory diagram showing an electric bicycle (power-assisted bicycle) as an example of a mobile unit using a motor/power generator as a modified example of the invention.

FIG. 7 is an explanatory diagram showing an example of a robot using the motor as a modified example of the invention.

FIG. 8 is an explanatory diagram showing an example of a dual-armed seven-axis robot using the motor as a modified example of the invention.

FIG. 9 is an explanatory diagram showing an example of a vertical articulated robot using the motor as a modified example of the invention.

FIG. 10 is an explanatory diagram showing an example of a dual-armed wheeled robot using the motor as a modified example of the invention.

FIG. 11 is an explanatory diagram showing a railcar as an example of a mobile unit using the motor as a modified example of the invention.

### DESCRIPTION OF EXEMPLARY EMBODIMENTS

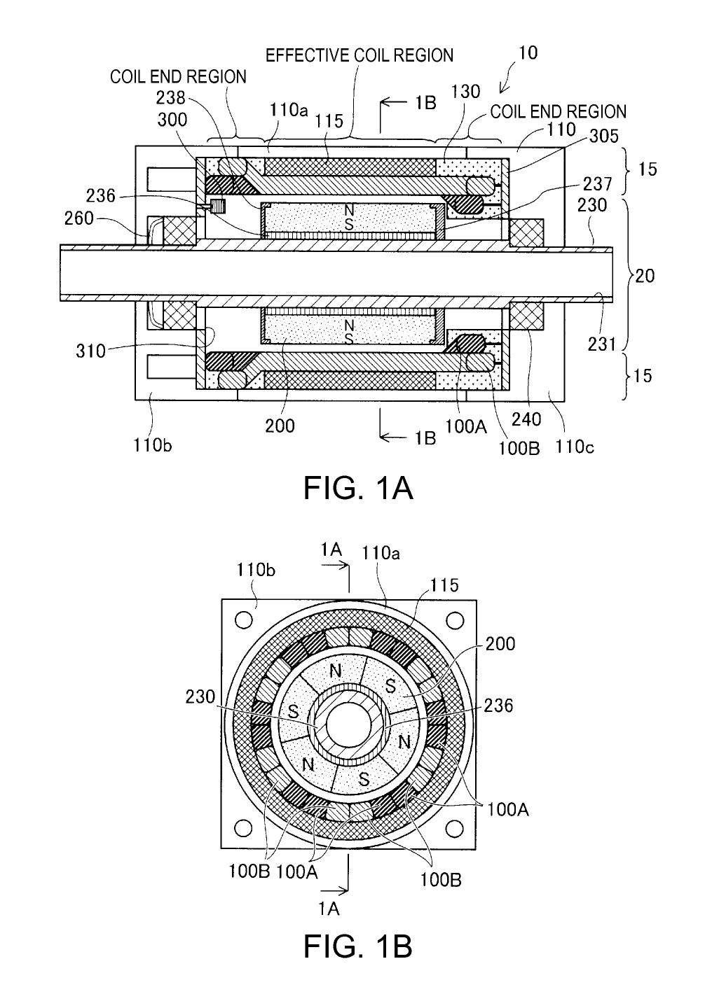

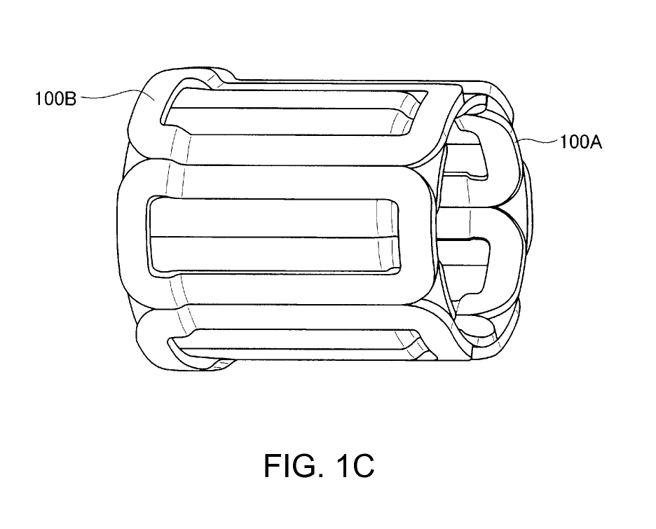

FIGS. 1A and 1B are explanatory diagrams showing a configuration of a coreless motor 10 as one embodiment of an electromechanical device. FIG. 1A schematically shows a section of the coreless motor 10 cut along a surface in parallel to a rotation shaft 230 (1A-1A cut surface of FIG. 1B), and FIG. 1B schematically shows a section of the coreless motor 10 cut along a surface perpendicular to the rotation shaft 230 (1B-1B cut surface of FIG. 1A).

The coreless motor 10 is an inner-rotor motor in which a nearly cylindrical stator 15 is provided at the outer side and a cylindrical rotor 20 is provided at the inner side. The stator 15 includes electromagnetic coils 100A, 100B, a casing 110, a coil back yoke 115, and a magnetic sensor 300. The rotor 20 includes the rotation shaft 230, rotor magnets 200, a magnet back yoke 236, magnet side yokes 237, 238, a bearing part 240, and a wave spring washer 260.

The rotor 20 has the rotation shaft 230 at the center and the cylindrical magnet back yoke 236 is fixed using an adhesive on the outer circumference of the rotation shaft 230. Further, on the outer circumference of the magnet back yoke 236, a plurality of (six in this example) rotor magnets 200 are nearly cylindrically fixed using an adhesive. For the plurality of rotor magnets 200, permanent magnets magnetized in directions from the center of the rotation shaft 230 toward the outside (radiation directions) and permanent magnets magnetized in directions from the outside toward the center of the rotation shaft 230 (center directions) are used. The rotor magnets magnetized in the radiation directions and the rotor magnets magnetized in the center directions are alternately arranged along the circumference direction. Signs “N” and “S” on the rotor magnets 200 in FIG. 1B indicate polarity of the magnetic poles at the outer circumference side of the rotor magnets 200. Note that, in the embodiment, the magnetization directions of the rotor magnets 200 are explained as radial directions (radiation directions or center directions), however, magnetization in parallel directions, not the radial directions, may be performed.

The magnet side yokes 237, 238 are fixed using an adhesive in end parts at both sides (side surfaces) of the rotor magnets 200 in the direction along the rotation shaft 230 (hereinafter, simply referred to as “shaft direction”). The magnet side yokes 237, 238 are nearly disc-shaped members formed using a soft magnetic material. The magnetic flux easily passes through the soft magnetic material than in the air, and thus, of the magnetic fluxes exiting from the rotor magnets 200, the magnetic fluxes leaking out in the shaft direction of the rotation shaft 230 are suppressed by the magnet side yokes 237, 238. Note that the specific structure of the surfaces at which the magnet side yokes 237, 238 are in contact with the rotor magnets 200 will be described later in detail.

The rotation shaft 230 is formed using a non-magnetic material such as carbon fiber reinforced plastics, and has a through hole 231. The rotation shaft 230 is supported by the bearing part 240 and attached to the casing 110. Further, in the embodiment, the wave spring washer 260 is provided inside of the casing 110. The wave spring washer 260 positions the rotor magnets 200. Note that the wave spring washer 260 is dispensable.

The casing 110 is a housing that houses the stator 15 and the rotor 20. The casing 110 includes a first casing part 110a as a cylindrical part at the center in the shaft direction and second and third casing parts 110b, 110c as lid parts at both ends. The first casing part 110a is formed using a material having high thermal conductivity such as aluminum.

The coil back yoke 115 is provided at the inner circumference side of the first casing part 110a. The length of the coil back yoke 115 in the shaft direction is nearly equal to the length of the rotor magnets 200 in the shaft direction. The first casing part 110a is formed using the material having the high thermal conductivity such as aluminum so that the heat generated in the coil back yoke 115 may be easily released to the outside. Note that the cause of the heat generated in the coil back yoke 115 may be loss due to eddy current generated with the rotation of the permanent magnets 200 of the rotor 20 (hereinafter, referred to as “eddy-current loss”). When radial lines are drawn in the radiation directions from the rotation shaft 230 toward the coil back yoke 115, the radial lines just penetrate the rotor magnets 200. That is, as seen from the rotation shaft 230, the coil back yoke 115 and the rotor magnets 200 have overlaps.

The two-phase electromagnetic coils 100A, 100B are arranged along the inner circumference of the coil back yoke 115 at the inner circumference side of the coil back yoke 115. When the two-phase electromagnetic coils 100A, 100B are not distinguished, the electromagnetic coils 100A, 100B are also collectively referred to as “electromagnetic coils 100”. Note that FIG. 1C is a schematic perspective view showing the electromagnetic coils 100 arranged along the inner circumference of the coil back yoke. There are pluralities of electromagnetic coils 100A, 100B, and respectively connected to a circuit board 305. The electromagnetic coils 100A, 100B have effective coil regions and coil end regions. Here, the effective coil regions are regions that provide Lorentz forces in the rotation direction to the rotor 20 when currents flow in the electromagnetic coils 100A, 100B, and the coil end regions are regions that provide Lorentz forces in a direction different from the rotation direction (mainly, in a direction perpendicular to the rotation direction) to the rotor 20 when currents flow in the electromagnetic coils 100A, 100B. Note that there are two coil end regions with the effective coil region in between, and their respective Lorentz forces have the same magnitude along opposite directions and cancel out each other. In the effective coil regions, the conductor wires forming the electromagnetic coils 100A, 100B are nearly in parallel to the rotation shaft 230, and, in the coil end regions, the conductor wires forming the electromagnetic coils 100A, 100B are in parallel to the rotation direction. Further, when radial lines are drawn in the radiation directions from the rotation shaft 230 toward the coil back yoke 115, the radial lines penetrate the effective coil regions, but do not penetrate the coil end regions. That is, as seen from the rotation shaft 230, the effective coil regions overlap with both the coil back yoke 115 and the rotor magnets 200, however, the coil end regions do not overlap with the rotor magnets 200 or the coil back yoke 115. The electromagnetic coils 100A, 100B overlap with the rotor magnets 200, however, in the coil end regions, the electromagnetic coils 100A, 100B do not overlap with the rotor magnets 200.

In the stator 15, one magnetic sensor 300 as a location sensor that detects the phase of the rotor 20 is further provided for each phase of the electromagnetic coils 100A, 100B. Note that, in FIG. 1A, only one magnetic sensor 300 is shown. The magnetic sensors 300 are fixed onto a circuit board 310 and the circuit board 310 is fixed to the casing 110.

Here, as described above, the magnet side yokes 237, 238 are provided to suppress the leakage of the magnetic fluxes from the rotor magnets 200 in the shaft directions, and it is necessary that the magnet side yoke 238 at the side at which the magnetic sensor 300 is provided permits leakage of the magnetic fluxes to the degree at which the magnetic sensor 300 can sense changes in magnetic flux. Accordingly, the thickness of the magnet side yoke 238 in the shaft direction at the side at which the magnetic sensor 300 is provided is set to be thinner than the thickness of the magnet side yoke 237 in the shaft direction at the opposite side to the side at which the magnetic sensor 300 is provided. Note that, in the case where an encoder is provided outside, the magnetic sensors 300 and the circuit board 310 are dispensable.

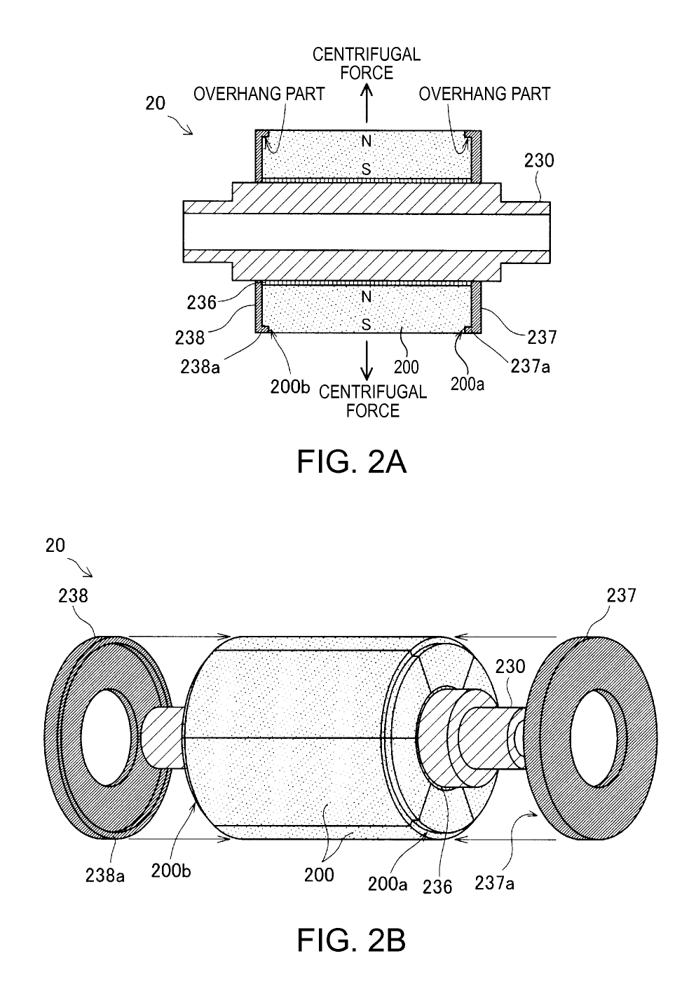

FIGS. 2A and 2B are explanatory diagrams showing a structure of surfaces at which the rotor magnets and the magnet side yokes are in contact. Note that FIG. 2A is a schematic sectional view showing enlarged parts of the rotor magnets 200 and the magnet side yokes 237, 238 (like FIG. 1A), and FIG. 2B is a schematic perspective view showing exploded parts of the magnet side yokes 237, 238 from the rotor 20.

As shown in FIG. 2A, concave parts 200a, 200b are formed in end parts of the outer circumference at both sides in the shaft direction of the rotor magnets 200, and circumferential convex parts 237a, 238a around the rotation shaft 230 are formed in correspondence with the concave parts 200a, 200b of the rotor magnets 200 in the end parts of the outer circumferences of the surfaces of the magnet side yokes 237, 238 at the rotor magnets 200 sides. Further, regarding the magnet side yokes 237, 238, the convex parts 237a, 238a of the magnet side yokes 237, 238 are fitted and fixed into the concave parts 200a, 200b of the rotor magnets 200 fixed along the outer circumference of the magnet back yoke 236. In the structure, first, as shown in FIG. 2B, the cylindrical magnet back yoke 236 is bonded along the outer circumference of the rotation shaft 230 with an adhesive. Then, the plurality of (six in the example of the drawing) rotor magnets 200 are bonded along the outer circumference of the magnet back yoke 236 with an adhesive. Then, the magnet side yokes 237, 238 are bonded to the end parts at both sides in the shaft direction of the rotor magnets 200 so that the convex parts 237a, 238a of the magnet side yokes 237, 238 may be fitted in the concave parts 200a, 200b of the rotor magnets 200. Note that balancers may be provided on the magnet side yokes 237, 238.

Centrifugal forces (shown by arrows in the drawing) in the radiation directions generated with the rotation of the rotor 20 are applied to the rotor magnets 200, and cause loose and detachment of the rotor magnets 200. However, in the case of the structure shown in FIGS. 2A and 2B, the convex parts 237a, 238a of the magnet side yokes 237, 238 function as overhang parts, and may limit the movement of the rotor magnets 200 in the radiation directions due to the centrifugal forces by suppressing the rotor magnets 200 with respect to the radiation directions when the rotor 20 rotates. Thereby, the problem that the rotor magnets 200 are loosened with the rotation of the rotor 20 and finally detached may be solved and the rotor 20 may be rotated at a high speed. Further, the outer circumference diameter of the rotor formed by the magnet surfaces may be stably held.

In addition, in the embodiment, the surfaces of the rotor magnets 200 intersecting with the shaft direction are covered by the magnet side yokes 237, 238, and thus, magnetic flux leakage from the rotor magnets 200 in the shaft direction may be suppressed. Further, the surfaces in the center directions of the rotor magnets 200 are covered by the magnet back yoke 236, and thus, magnetic flux leakage in the center directions of the rotor magnets 200 may be suppressed by the magnet back yoke 236. Furthermore, for the rotation shaft 230, a non-magnetic material, for example, a resin composite material such as CFRP (carbon fiber reinforced plastics) or GFRP (glass fiber reinforced plastics), ceramics, a dietary fiber material, a resin material, or the like may be used, and reduction in weight becomes easier.

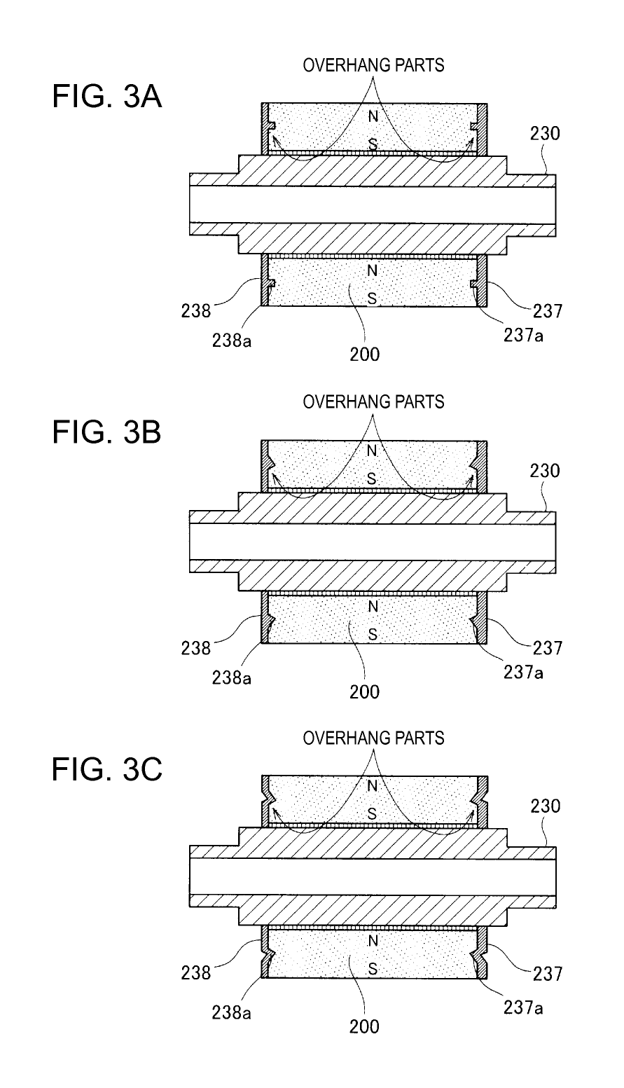

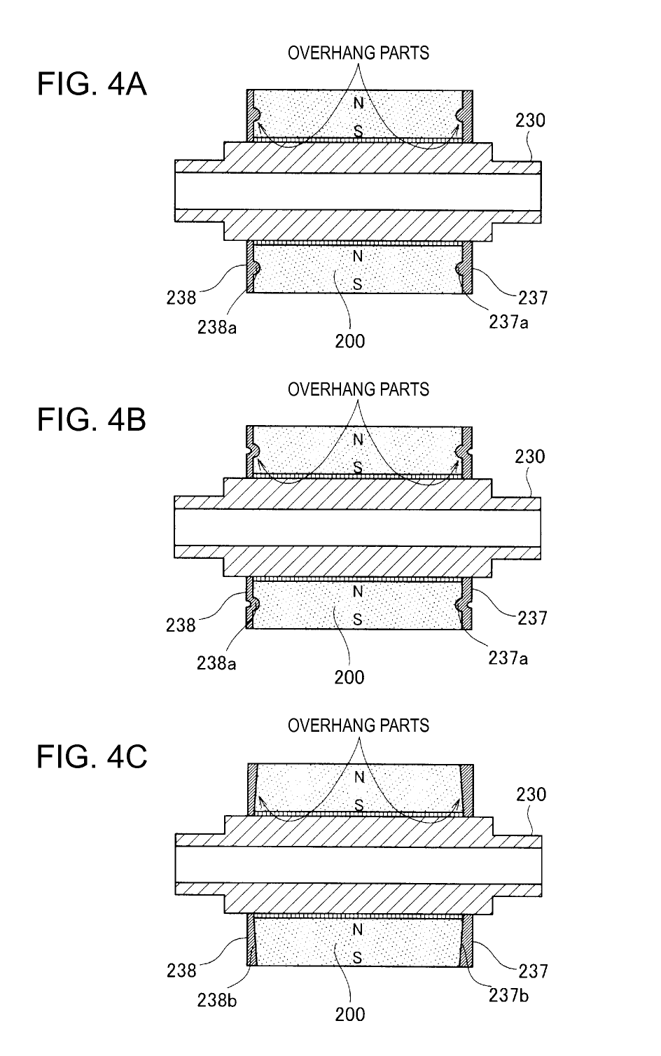

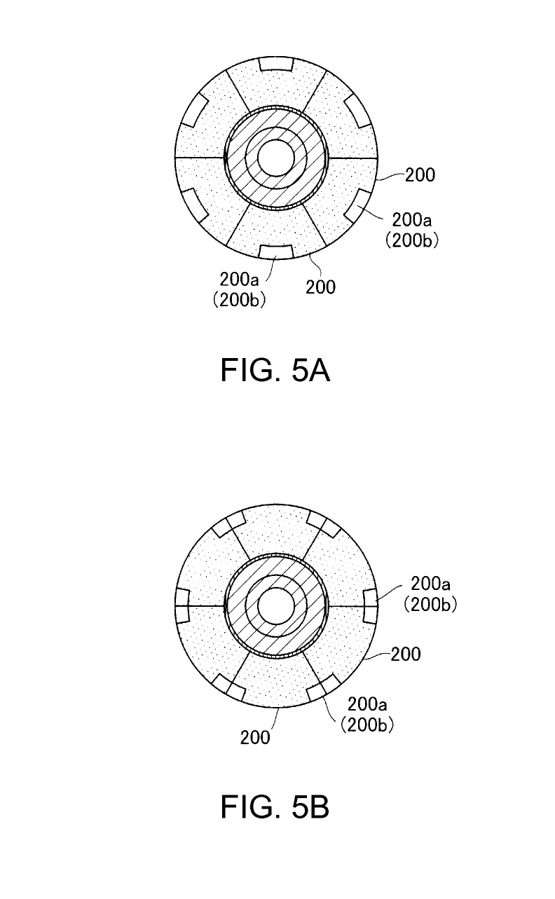

FIGS. 3A to 5B are explanatory diagrams showing modified examples of the overhang parts of the magnet side yokes. FIGS. 3A to 4C are schematic sectional views showing enlarged parts of the rotor magnets and the magnet side yokes like FIG. 2A, and FIGS. 5A and 5B are schematic plan views showing enlarged surfaces of the rotor magnets in contact with the magnet side yokes. FIGS. 3A, 3B, 3C and FIGS. 4A and 4B show examples in which, of the surfaces of the magnet side yokes 237, 238 in contact with the rotor magnets 200, the circumferential convex parts 237a, 238a formed in the intermediate part between the inner circumferential end and the outer circumferential end are the overhang parts. The shapes of the convex parts may be various shapes including rectangular shapes, chevron shapes, and semicircular shapes. Further, FIG. 4C shows an example in which, regarding the surfaces from the inner circumferential end to the outer circumferential end of the magnet side yokes 237, 238 in contact with the rotor magnets 200, surfaces 237b, 238b formed to incline toward the rotor magnets 200 sides from the inner circumferential end toward the outer circumferential end are the overhang parts. Furthermore, the overhang parts are not necessarily formed entirely circumferentially along the circumference of the rotation shaft 230, but, for example, as shown in FIGS. 5A and 5B, the parts may be formed in the center parts or the peripheral parts in the outer circumferential ends of the sector shapes of the respective rotor magnets 200. Note that, although FIGS. 5A and 5B correspond to the shapes shown in FIGS. 2A and 2B, the same applies to the other shapes shown in FIGS. 3A to 4C. As explained above, it is only necessary that the overhang parts formed on the magnet side yokes may suppress the rotor magnets with respect to the radiation directions perpendicular to the shaft direction and directed from the center of the rotational shaft to the outer circumference and limit the movements of the rotor magnets in the radiation directions.

Note that, in the embodiment, the coreless motor having the characterized parts of the invention has been explained, however, the invention may be applied, not limited to the coreless motor as the motor, but to a power generator. Further, the motor and the power generator having the features of the invention may be applied as a driver of an electric mobile unit, an electric mobile robot, or a medical device.

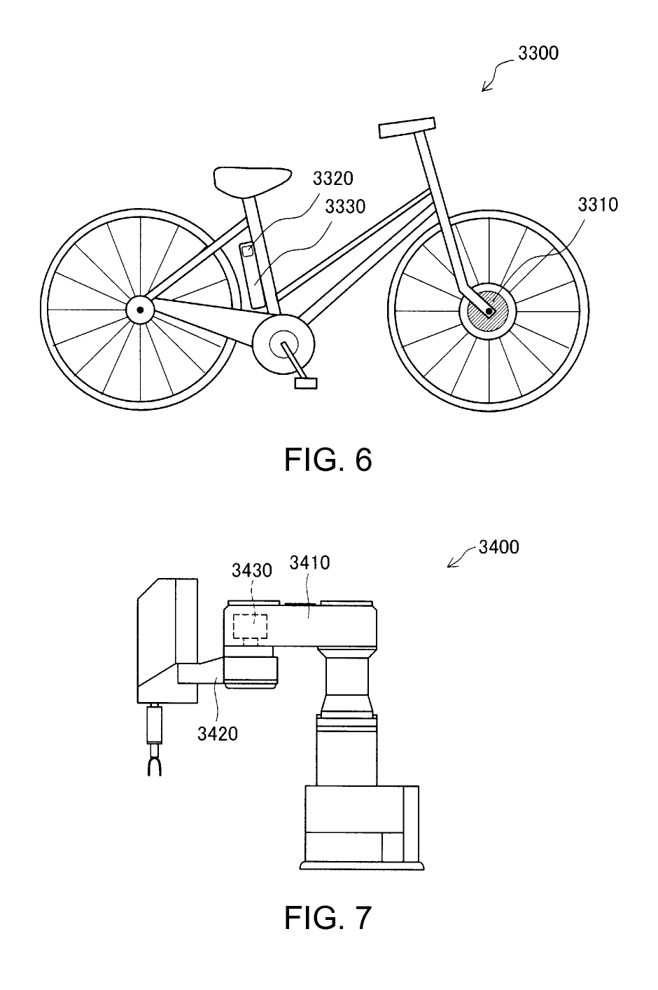

FIG. 6 is an explanatory diagram showing an electric bicycle (power-assisted bicycle) as an example of a mobile unit using a motor/power generator as a modified example of the invention. A bicycle 3300 is provided with a motor 3310 on a front wheel, and a control circuit 3320 and a rechargeable battery 3330 on a frame below a saddle. The motor 3310 drives the front wheel using power from the rechargeable battery 3330, and thereby, assists traveling. Further, at braking, the power regenerated by the motor 3310 is charged in the rechargeable battery 3330. The control circuit 3320 is a circuit that controls driving and regeneration of the motor. As the motor 3310, the above described various coreless motors 10 may be used.

FIG. 7 is an explanatory diagram showing an example of a robot using the motor as a modified example of the invention. A robot 3400 has first and second arms 3410, 3420 and a motor 3430. The motor 3430 is used when the second arm 3420 as a driven member is horizontally rotated. As the motor 3430, the above described various coreless motors 10 may be used.

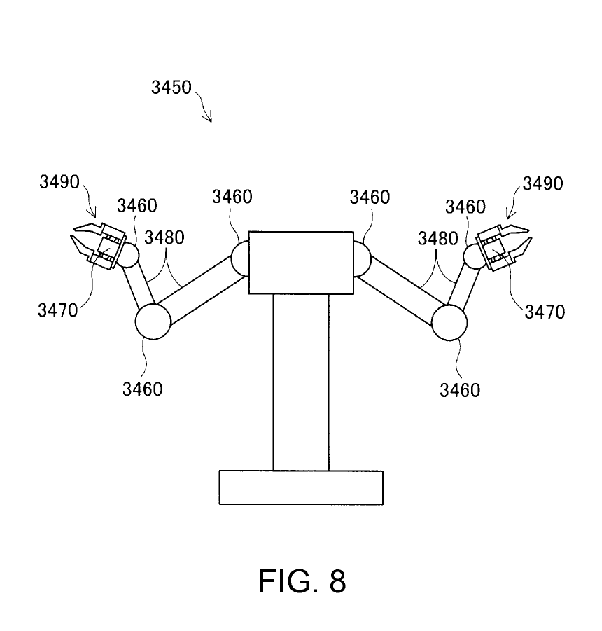

FIG. 8 is an explanatory diagram showing an example of a dual-armed seven-axis robot using the motor as a modified example of the invention. A dual-armed seven-axis robot 3450 includes joint motors 3460, grasping part motors 3470, arms 3480, and grasping parts 3490. The joint motors 3460 are provided in locations corresponding to shoulder joints, elbow joints, and wrist joints. The joint motors 3460 include two motors for each joint for three-dimensional movements of the arms 3480 and the grasping parts 3490. Further, the grasping part motors 3470 open and close the grasping parts 3490 and allow the grasping parts 3490 to grasp objects. In the dual-armed seven-axis robot 3450, as the joint motors 3460 and the grasping part motors 3470, the above described various coreless motors 10 may be used.

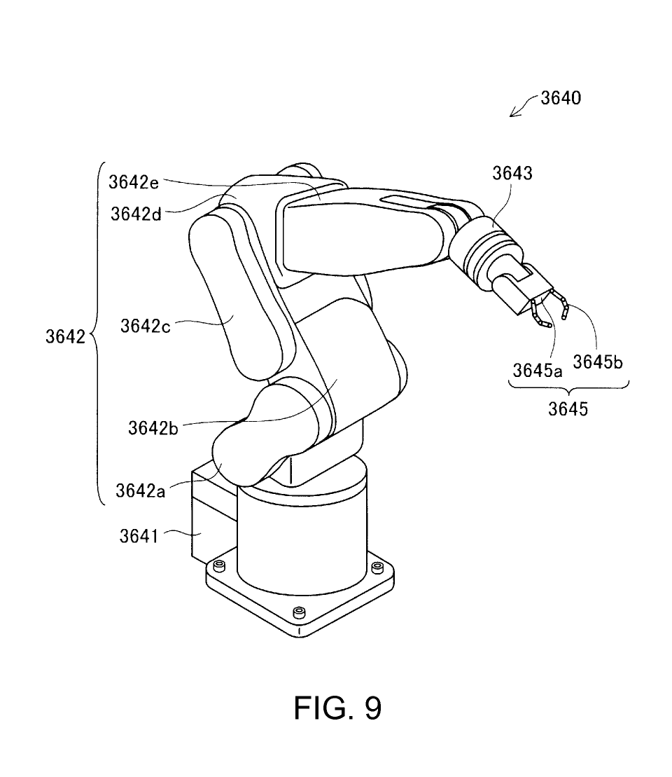

FIG. 9 is an explanatory diagram showing an example of a vertical articulated robot using the motor as a modified example of the invention. As shown in FIG. 9, a vertical articulated robot 3640 includes a main body part 3641, an arm part 3642, a robot hand 3645, etc. The main body part 3641 is fixed onto a floor, a wall, a ceiling, a movable carriage, or the like, for example. The arm part 3642 is movably provided with respect to the main body part 3641, and the main body part 3641 contains a drive unit (not shown) that generates power for rotation of the arm part 3462, a control unit that controls the drive unit, etc. As the drive unit, the above described coreless motor 10 may be used.

The arm part 3462 includes a first frame 3642a, a second frame 3642b, a third frame 3642c, a fourth frame 3642d, and a fifth frame 3642e. The first frame 3642a is rotatably or foldably connected to the main body part 3641 via a rotation and folding shaft. The second frame 3642b is connected to the first frame 3642a and the third frame 3642c via the rotation and folding shafts. The third frame 3642c is connected to the second frame 3642b and the fourth frame 3642d via the rotation and folding shafts. The fourth frame 3642d is connected to the third frame 3642c and the fifth frame 3642e via the rotation and folding shafts. The fifth frame 3642e is connected to the fourth frame 3642d via the rotation and folding shaft. The arm part 3462 is adapted to move with the respective frames 3462a to 3462e rotating or folding around the respective rotation and folding shafts in a complex manner under the control of the control unit (not shown).

Of the fifth frame 3642e of the arm part 3462, at the opposite side to the side at which the fourth frame 3642d is provided, a hand connection part 3643 is connected, and the robot hand 3645 is attached to the hand connection part 3643.

The robot hand 3645 includes a base part 3645a and a finger part 3645b connected to the base part 3645a. The above described various coreless motors are incorporated into the connection part of the base part 3645a and the finger part 3645b and the respective joint parts of the finger part 3645b. The coreless motors are driven, and thereby, the finger part 3645b may fold and grasp an object. The coreless motors are micro motors, and may realize the robot hand 3645 that reliably grasp the object despite its compact size. Thereby, a versatile robot that can perform complex movements using the small and light robot hand 3645 may be provided.

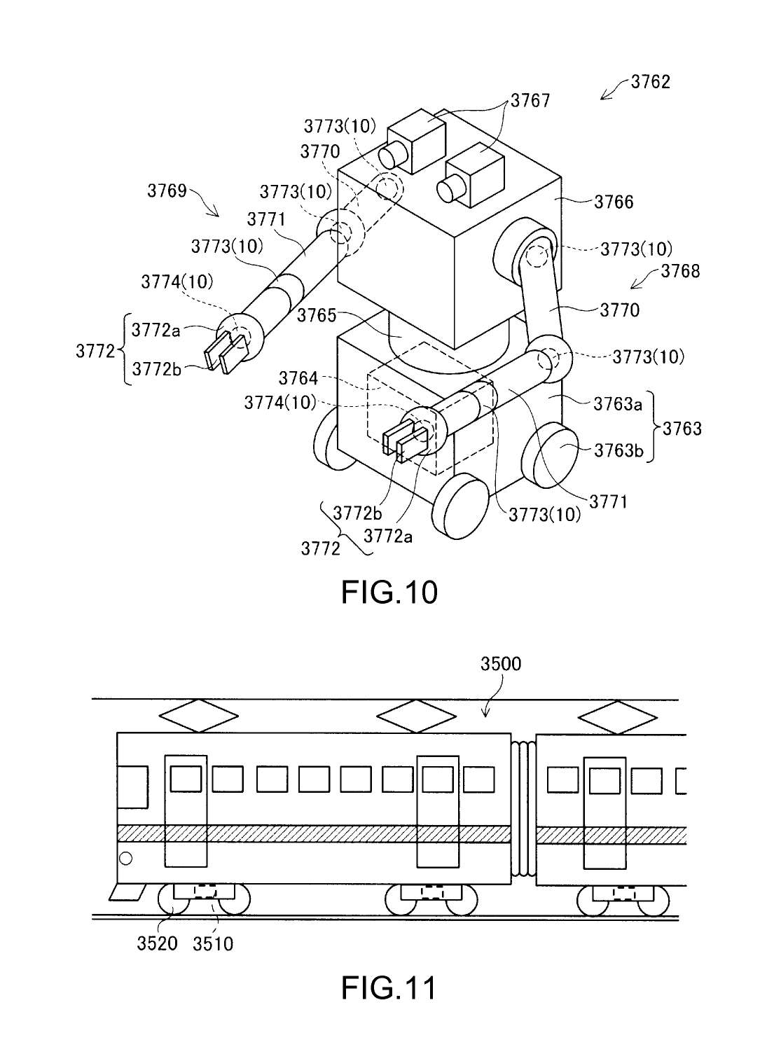

FIG. 10 is an explanatory diagram showing an example of a dual-armed wheeled robot using the motor as a modified example of the invention. As shown in FIG. 10, a dual-armed wheeled robot 3762 includes a wheeled part 3763. The wheeled part 3763 includes a wheeled part main body 3763a, and four wheels 3763b are provided at the ground side of the wheeled part main body 3763a. Further, the wheeled part main body 3763a contains a rotation mechanism that drives the wheels 3763b. Furthermore, the wheeled part main body 3763a contains a control unit 3764 that controls the position and the movement of the robot 3762.

On the wheeled part main body 3763a, a main body rotation part 3765 and a main body part 3766 are mounted in this order. In the main body rotation part 3765, a rotation mechanism that rotates the main body part 3766 is provided. Further, the main body part 3766 rotates with the vertical direction as a rotation center. A pair of imaging devices 3767 are provided on the main body part 3766 and the imaging devices 3767 image surroundings of the dual-armed wheeled robot 3762. Thereby, the distances between the imaged object and the imaging devices 3767 may be detected.

Of the side surfaces of the main body part 3766, on two opposed surfaces, a left arm part 3768 and a right arm part 3769 are provided. The left arm part 3768 and the right arm part 3769 each has an upper arm part 3770, a lower arm part 3771, and a hand part 3772 as movable parts. The upper arm parts 3770, the lower arm parts 3771, and the hand parts 3772 are rotatably or foldably connected. Further, the main body part 3766 contains rotation mechanisms 3773 that rotate the upper arm parts 3770 with respect to the main body part 3766. The upper arm part 3770 contains the rotation mechanism 3773 that rotates the lower arm part 3771 with respect to the upper arm part 3770. The lower arm part 3771 contains the rotation mechanism 3773 that rotates the hand part 3772 with respect to the lower arm part 3771. Furthermore, the lower arm part 3771 contains the rotation mechanism 3773 that twists around the longitudinal direction of the lower arm part 3771 as a rotation axis.

The hand part 3772 includes a hand main body 3772a and a pair of grasping parts 3772b as plate-like movable parts located on the tip of the hand main body 3772a. The hand main body 3772a contains a direct action mechanism 3774 that changes the distance between the grasping parts 3772b by moving the grasping parts 3772b. The hand part 3772 may grasp an object to be grasped by opening and closing the grasping parts 3772b.

The rotation mechanism 3773 and the direct action mechanism 3774 include the careless motors 10 and decelerators. Therefore, even when the rotation mechanism 3773 reverses the rotation direction, the mechanism may smoothly reverse the rotation direction without wobbles. Further, even when the direct action mechanism 3774 reverses the movement direction, the mechanism may smoothly reverse the movement direction without wobbles. Therefore, the dual-armed wheeled robot 3762 may move the left arm part 3768 and the right arm part 3769 with high location accuracy.

Furthermore, the rotation mechanism that rotates the wheels 3763b and the rotation mechanism that rotates the main body part 3766 include the coreless motors 10 and decelerators. Therefore, even when the dual-armed wheeled robot 3762 changes the traveling direction, the robot may rotate without wobbles. Further, even when the dual-armed wheeled robot 3762 changes the rotation direction of the main body part 3766, the robot may rotate the part without wobbles.

FIG. 11 is an explanatory diagram showing an example of a railcar using the motor as a modified example of the invention. A railcar 3500 has electric motors 3510 and wheels 3520. The electric motors 3510 drive the wheels 3520. Further, the electric motors 3510 are used as power generators at braking of the railcar 3500, and regenerate power. As the electric motors 3510, the above described various coreless motors 10 may be used.

The invention is not limited to the above described embodiments, working examples, and modified examples, but may be realized in various configurations without departing from the scope thereof. For example, in order to solve part or all of the above described problems or in order to achieve part or all of the above described effects, replacements and combinations may be appropriately made with respect to the technical features in the embodiments, the working examples, and the modified examples corresponding to the technical features in the respective embodiments described in “SUMMARY”. Further, if the technical features have not been explained as essential matter in the specification, they may be appropriately deleted.

The entire disclosure of Japanese Patent Application No. 2012-211700 filed Sep. 26, 2012 is expressly incorporated by reference herein.

What is claimed is:

1. An electromechanical device comprising:
a rotor; and
a stator provided on an outer circumference of the rotor,
the rotor including
a rotation shaft,
a plurality of rotor magnets cylindrically fixed and arranged along an outer circumference of the rotation shaft, and
two magnet side yokes fixed and arranged in contact with side surfaces at both sides of the rotor magnets in a shaft direction of the rotation shaft,
wherein overhang parts that suppress the rotor magnets with respect to radiation directions from a center of the rotation shaft toward the outer circumference and limit movements of the rotor magnets in the radiation directions are provided on surfaces of the magnet side yokes in contact with the rotor magnets.

2. The electromechanical device according to claim 1, wherein the overhang parts are formed by convex parts projecting to the surface sides of the rotor magnets.

3. The electromechanical device according to claim 2, wherein concave parts that engage with the convex parts of the overhang parts are formed on the rotor magnets.

4. The electromechanical device according to claim 1, wherein the magnet side yokes are members formed using a soft magnetic material.

5. The electromechanical device according to claim 1, wherein at least part of the magnet side yokes covers surfaces of the rotor magnets intersecting with the rotation shaft.

6. The electromechanical device according to claim 1, wherein at least part of the magnet side yokes covers surfaces of the rotor magnets in directions toward the center.

7. The electromechanical device according to claim 1, wherein one of the magnet side yokes has a thickness set to be thinner in the rotation shaft direction than that of the other so that a magnet sensor adjacently provided may sense changes in magnetic flux.

8. A mobile unit comprising the electromechanical device according to claim 1.

9. A rotor provided on an inner circumference of a stator of an electromechanical device, comprising:
a rotation shaft;
a plurality of rotor magnets cylindrically fixed and arranged along an outer circumference of the rotation shaft; and
two magnet side yokes fixed and arranged in contact with side surfaces at both sides of the rotor magnets in a shaft direction of the rotation shaft,
wherein overhang parts that suppress the rotor magnets with respect to radiation directions from a center of the rotation shaft toward the outer circumference and limit movements of the rotor magnets in the radiation directions are provided on surfaces of the magnet side yokes in contact with the rotor magnets.

10. The rotor according to claim 9, wherein the magnet side yokes are members formed using a soft magnetic material.

11. The rotor according to claim 9, wherein at least part of the magnet side yokes covers surfaces of the rotor magnets intersecting with the rotation shaft.

12. The rotor according to claim 9, wherein at least part of the magnet side yokes covers surfaces of the rotor magnets in directions toward the center.

13. The rotor according to claim 9, wherein one of the magnet side yokes has a thickness set to be thinner in the rotation shaft direction than that of the other so that a magnet sensor adjacently provided may sense changes in magnetic flux.

14. A robot comprising an electromechanical device including a rotor and a stator provided on an outer circumference of the rotor,
the rotor including
a rotation shaft,
a plurality of rotor magnets cylindrically fixed and arranged along an outer circumference of the rotation shaft, and
two magnet side yokes fixed and arranged in contact with side surfaces at both sides of the rotor magnets in a shaft direction of the rotation shaft,
wherein overhang parts that suppress the rotor magnets with respect to radiation directions from a center of the rotation shaft toward the outer circumference and limit movements of the rotor magnets in the radiation directions are provided on surfaces of the magnet side yokes in contact with the rotor magnets.

15. The robot according to claim 14, wherein the overhang parts are formed by convex parts projecting to the surface sides of the rotor magnets.

16. The robot according to claim 15, wherein concave parts that engage with the convex parts of the overhang parts are formed on the rotor magnets.

17. The robot according to claim 14, wherein the magnet side yokes are members formed using a soft magnetic material.

18. The robot according to claim 14, wherein at least part of the magnet side yokes covers surfaces of the rotor magnets intersecting with the rotation shaft.

19. The robot according to claim 14, wherein at least part of the magnet side yokes covers surfaces of the rotor magnets in directions toward the center.

20. The robot according to claim 14, wherein one of the magnet side yokes has a thickness set to be thinner in the rotation shaft direction than that of the other so that a magnet sensor adjacently provided may sense changes in magnetic flux.
